(19) United States
(12) Patent Application Publication
(10) Pub. No.: US 2011/0205378 A1
(43) Pub. Date: Aug. 25, 2011

(54) IMAGE TAKING APPARATUS

(75) Inventor: Hideo KOBAYASHI, Saitama (JP)

(73) Assignee: FUJIFILM CORPORATION, Tokyo (JP)

(21) Appl. No.: 13/028,527

(22) Filed: Feb. 16, 2011

(30) Foreign Application Priority Data
Feb. 23, 2010 (JP) 2010-037507

(51) Int. Cl. H04N 5/228

(52) U.S. Cl. 348/208.11; 348/E05.046

(57) ABSTRACT

An image taking apparatus includes: a CCD plate in which a CCD image sensor is disposed; a base member that supports the CCD plate so that the CCD image sensor is movable within a plane perpendicular to an optical axis in which the CCD image sensor receives subject light; a drive system that drives an imaging section so that image blurring corrected; and a CCD flexible circuit board that transmits image signals generated by the CCD image sensor to a main-unit circuit board. A middle part between the both ends of the CCD flexible circuit board has a shape of being bent in a direction of preventing the CCD plate from falling to thereby support the CCD plate elastically.

### BACKGROUND OF THE INVENTION

1. Field of the Invention

The present invention relates to an image taking apparatus.

2. Description of the Related Art

Conventionally, there is known an image taking apparatus that guides subject light by an image-taking optical system, forms a subject image based on this subject light on an imaging element, and captures image signals representing the subject image. Further, as the imaging element, for example, Charge Coupled Device (CCD) image sensors, Complementary Metal Oxide

Semiconductor (CMOS) image sensors of low-cost and low-power, and the like are widely used.

Furthermore, conventionally, among image taking apparatus, there is an apparatus having a built-in image-blur correcting device to suppress turbulence in a shot image resulting from camera shake by a user. For example, there is known an image-blur correcting device that includes, a correcting lens, and a magnet and a coil for moving the correcting lens, and suppresses an image blur by moving the correcting lens (see, for example, Japanese Patent Application Publication No. 11-258649). In this image-blur correcting device, a flexible printed circuit board that supplies electric power to a coil is placed between a holding frame that holds the correcting lens and a fixed member, to cancel gravity acting on the image-blur correcting device by using the elasticity of the flexible printed circuit board.

However, the number of conductors required for sending the electric power to the coil is around several, and there is a limit to the elasticity of the flexible printed circuit board. Increasing the width or thickness of the flexible printed circuit board for the purpose of reinforcing the elasticity is against a demand for size and cost reductions in the image taking apparatus.

### SUMMARY OF THE INVENTION

In view of the foregoing circumstances, it is an object of the present invention to provide an image taking apparatus which may firmly support the weight of a movable section for blur correction, while avoiding an increase in the size of the flexible printed circuit board.

Here, the “imaging element” according to the present invention refers to an image sensor such as a CCD (Charge Coupled Device) image sensor or a CMOS (Complementary Metal Oxide Semiconductor) image sensor.

The image taking apparatus of the present invention corrects a blur by moving the imaging section where the imaging element is disposed, and the imaging section is elastically supported by the flexible circuit board that transmits the image signals generated by the imaging element to the signal processing circuit board. The number of image signals transmitted from the imaging element is so large as compared to the case of coil, and the flexible circuit board has a broader width and thus has stronger elasticity. With supporting the imaging section by using the flexible circuit board that transmits the image signals generated by the imaging element to the signal processing circuit board, it is possible to support a movable section for blur correction with stronger elasticity, while avoiding an increase in the size of an existing flexible printed circuit board.

### BRIEF DESCRIPTION OF THE DRAWINGS

FIG. 1 is a perspective diagram of a digital camera that is one embodiment of the image taking apparatus of the present invention, when its front is viewed obliquely from above;

FIG. 2 is a perspective diagram of the digital camera that is the one embodiment of the image taking apparatus of the present invention, when its back is viewed obliquely from above;

FIG. 3 is a cross-sectional diagram of an internal structure of a lens barrel illustrated in FIG. 1, in a direction along an optical axis;

FIG. 4 is a diagram of a base illustrated in FIG. 3 when viewed from an image-forming side;

FIG. 5 is a diagram of the base illustrated in FIG. 3 when viewed from a subject side; and

FIG. 6 is a perspective diagram of a first slider and a second slider illustrated in FIG. 5 when viewed from the subject side.

### DETAILED DESCRIPTION OF THE INVENTION

An exemplary embodiment of the present invention will be described below with reference to the drawings.

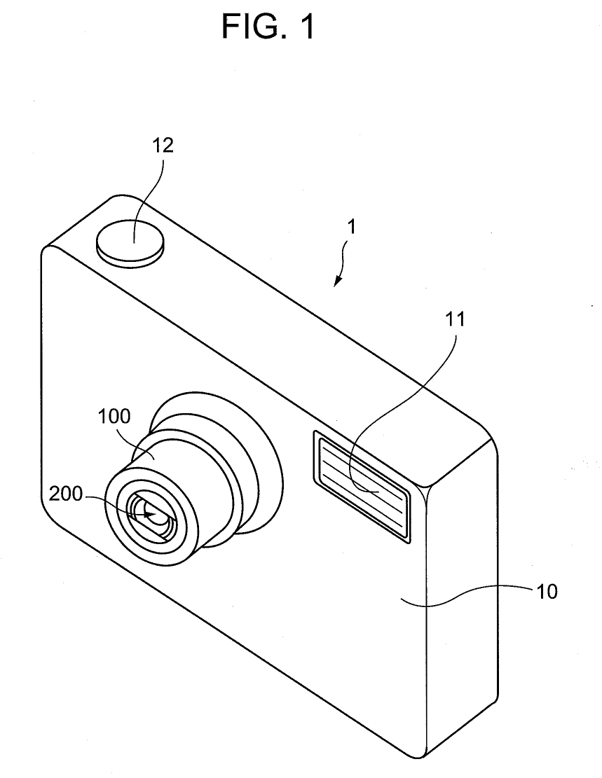

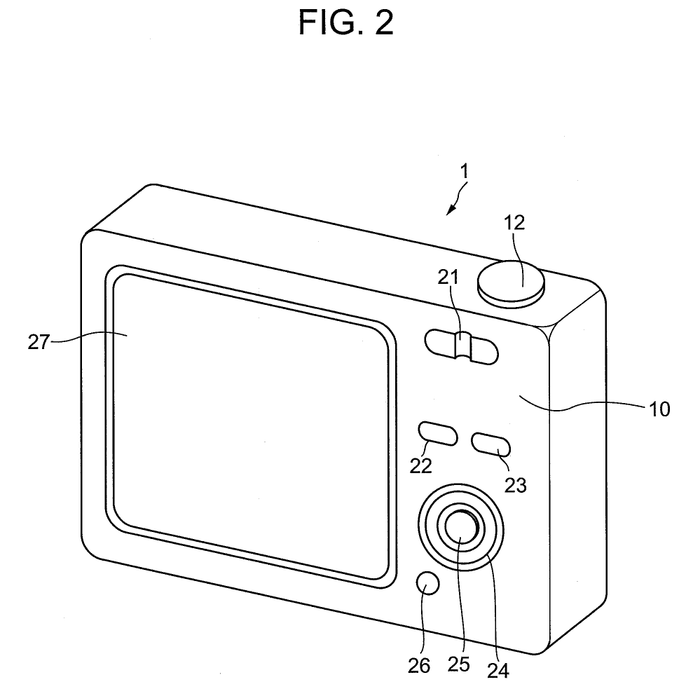

FIG. 1 and FIG. 2 are perspective diagrams of a digital camera 1 that is one embodiment of the image taking apparatus of the present invention, when its front and back are viewed obliquely from above, respectively.

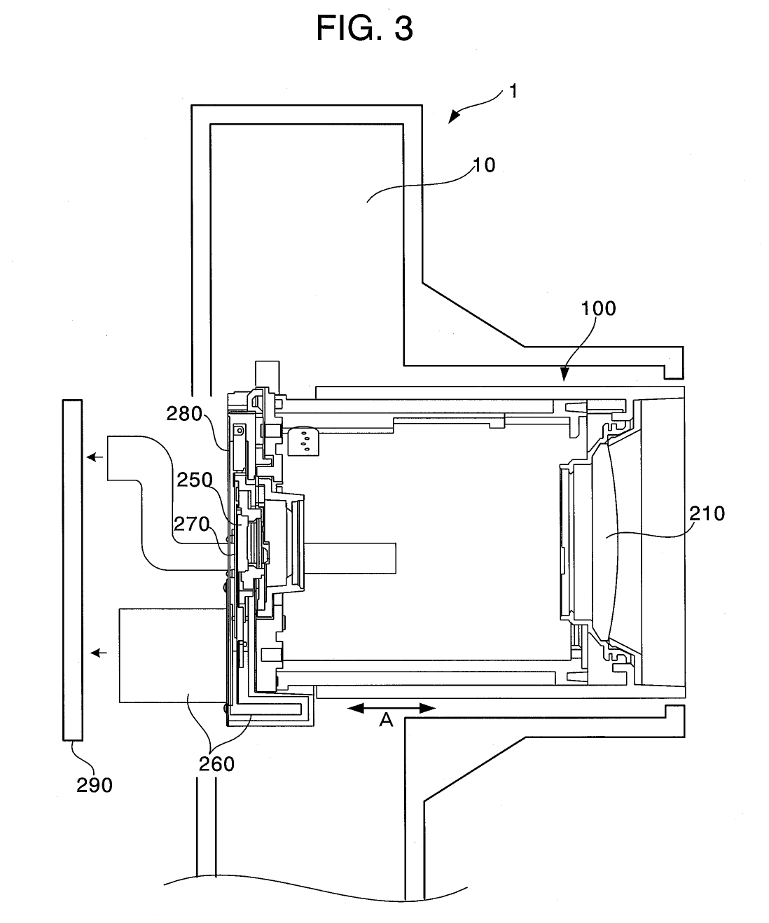

There is illustrated, in the front of the digital camera 1, a lens barrel 100 protruding from a camera main unit 10. Further, in this lens barrel 100, there are incorporated: a zoom lens capable of changing a focal distance, and an image forming lens 200 that forms an image of a subject on a CCD image sensor 250 (see FIG. 3 to FIG. 6) that generates image signals representing a subject image by receiving subject light, and thereby forms the subject image. This CCD image sensor 250 (see FIG. 3 to FIG. 6) is one embodiment of the imaging element according to the present invention, and the image forming lens 200 is one embodiment of the image-taking optical system according to the present invention.

Furthermore, in the front of this digital camera 1, a flash emitting section 11 that emits a flash at the time of shooting is provided, and on the top of this digital camera 1, a shutter release 12 that gives a shooting instruction to this digital camera 1 and is capable of being depressed in two phases of a half push and a full push is disposed.

In addition, on the back illustrated in FIG. 2 of this digital camera 1, there are provided: a T/W (tele/wide) switch lever 21, a photography/playback switch button 22, a function button 23, a four-way key 24, an OK key 25, a DISP/BACK key 26, and an LCD panel 27 for displaying an image.

Here, the T/W switch lever 21 is a lever for switching the focal distance of the image forming lens 200. Further, the photography/playback switch button 22 is a button for switching the mode of this digital camera 1 between a photography mode and a playback mode each time the button is pressed.

When the function button 23 is pressed, a menu is displayed on the LCD panel 27. Subsequently, when the menu is changed with right and left buttons of the four-way key 24, and then any of items in the menu is selected with up and down buttons of the four-way key 24, the selected item is set by pressing the OK button 25. This operation sets, for example, ISO speed, the present/absence of flash remission, and others including various items in the photography mode or the playback mode.

The DISP/BACK key 26 is to be pressed when, for example, sequentially switching the display form (for example, between display of only a single image and display of thumbnail images) of an image displayed on the LCD panel 27 in the playback mode, or when returning a display screen to a previous image.

The CCD image sensor 250 (see FIG. 3 to FIG. 6) incorpoted in this digital camera 1 is movable within a plane perpendicular to an optical axis, and in this digital camera 1, an image-blur correcting system that corrects an image blur by moving the CCD image sensor 250 (see FIG. 3 to FIG. 6) according to camera shake is incorporated.

The image-blur correcting system will be described below with reference to FIG. 3 to FIG. 6.

FIG. 3 is a cross-sectional diagram of an internal structure of the lens barrel 100 illustrated in FIG. 1, in a direction along the optical axis, and illustrates a shooting state.

In the lens barrel 100 illustrated in FIG. 3, there is incorporated the image forming lens 200 (see FIG. 1) that includes lens groups and a focus lens, and is configured such that any or all of the lenses move in an arrow-A direction that is an optical axis direction, according to the switching between the tele/wide (T/W) switching or a focus adjustment. However, here, among the lenses of the image forming lens 200, only a first lens group 210 disposed closest to the subject is illustrated. Further, the lens barrel 100 is fixed to a base 280 of the camera main unit 10 (see FIG. 1 and FIG. 2).

The CCD image sensor 250 illustrated in FIG. 3 receives subject light and generates image signals presenting a subject image. This CCD image sensor 250 is adhered to be fixed to a CCD plate 270 such that one end of a CCD flexible circuit board 260 connected to the CCD image sensor 250 by soldering is disposed on a rear surface side. The CCD plate 270, to which the CCD image sensor 250 is adhered to be fixed, is supported by the base 280 so as to be freely movable within the plane which is perpendicular to the optical axis in which the CCD image sensor 250 receives the subject light. Such a CCD plate 270 is driven so that an image blur is corrected. This CCD plate 270 is one embodiment of the imaging section according to the present invention. Incidentally, a drive system of the CCD plate 270 will be described later.

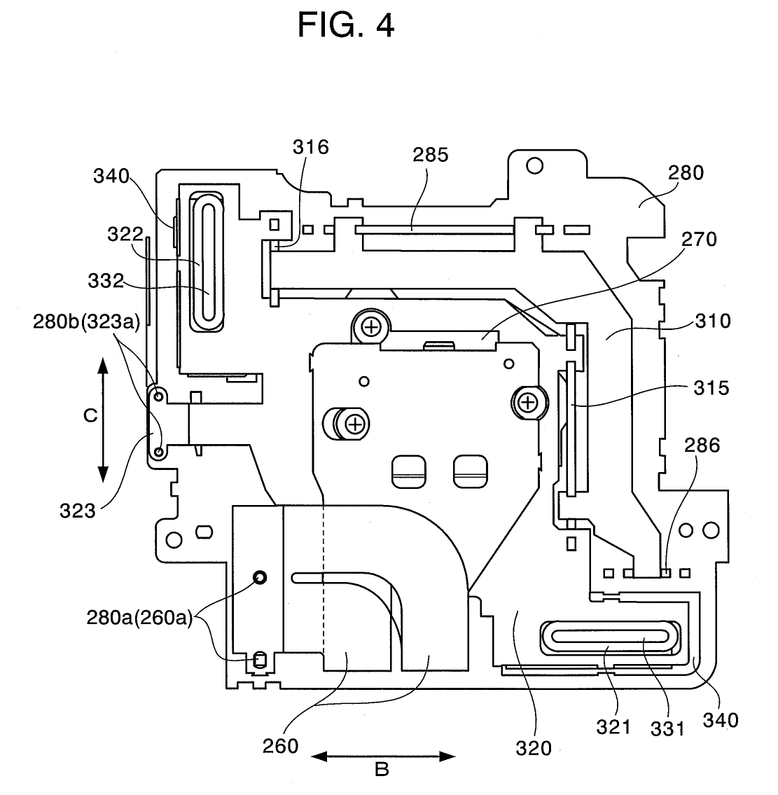

The CCD flexible circuit board 260 is shaped like a belt, in which a metal conductor is sandwiched between resin films. Such a CCD flexible circuit board 260 transmits image signals generated by the CCD image sensor 250 to a main-unit circuit board 290 for image-signal processing attached to the camera main unit 10 (See FIG. 1 and FIG. 2). The other end of the CCD flexible circuit board 260 with the one end connected to the CCD image sensor 250 is connected to the main-unit circuit board 290 of the camera main unit 10 (See FIG. 1 and FIG. 2). Further, a middle part between the both ends has a shape of being bent in a direction of preventing the CCD plate 270 from falling, to thereby support the CCD plate 270 elastically. In other words, the CCD flexible circuit board 260 extends vertically downward from the CCD plate 270, bends and extends in the direction of the optical axis at a tip of this downward extension, wraps around while forming a shape like approximately a letter U at a tip of the extension in the direction of the optical axis, and then comes back. Then, the CCD flexible circuit board 260 bends and extends upward, and then extends in a lateral direction at a tip of the upward extension, as clearly illustrated in FIG. 4, and a part at the end of this extension is connected to the main-unit circuit board 290 of the camera main unit 10 (See FIG. 1 and FIG. 2). Apertures 260a for fixing are formed in a middle portion of the part at the end of the bending and extension of the CCD flexible circuit board 260, and when bosses 280a formed to protrude on the base 280 are inserted into these apertures 260a, the part at the end of the bending and extension of the CCD flexible circuit board 260 is fixed to the base 280. Here, upward and downward directions refer to a vertical direction in a standard posture as illustrated in FIG. 1 and FIG. 2 of a user when the user holds the camera main unit 10 (See FIG. 1 and FIG. 2) with the shutter release 12 directed upward at the time of shooting. This CCD flexible circuit board 260 is one embodiment of the flexible circuit board according to the present invention. Further, the main-unit circuit board 290 is one embodiment of the signal processing circuit board according to the present invention, and the base 280 is one embodiment of the base member according to the present invention.

The image-blur correcting system in the present embodiment is provided with the CCD flexible circuit board 260. The one end of the CCD flexible circuit board 260 is connected to the CCD image sensor 250 of the CCD plate 270 that is supported by the base 280 of the camera main unit 10 so as to be freely movable within the plane in which the CCD image sensor 250 receives the subject light and which is perpendicular to the optical axis, whereas the other end of the CCD flexible circuit board 260 is connected to the main-unit circuit board 290 of the camera main unit 10. The CCD flexible circuit board 260 transmits the image signals generated by the CCD image sensor 250 to the main-unit circuit board 290. The middle part between the both ends of the CCD flexible circuit board 260 has a shape of being bent in the direction of preventing the CCD plate 270 from falling, to thereby support the CCD plate 270 elastically. The weight of the CCD plate 270 that is a movable section is supported by the CCD flexible circuit board 260.

Next, the drive system that drives the CCD image sensor 250 so that image blurring is corrected will be described.

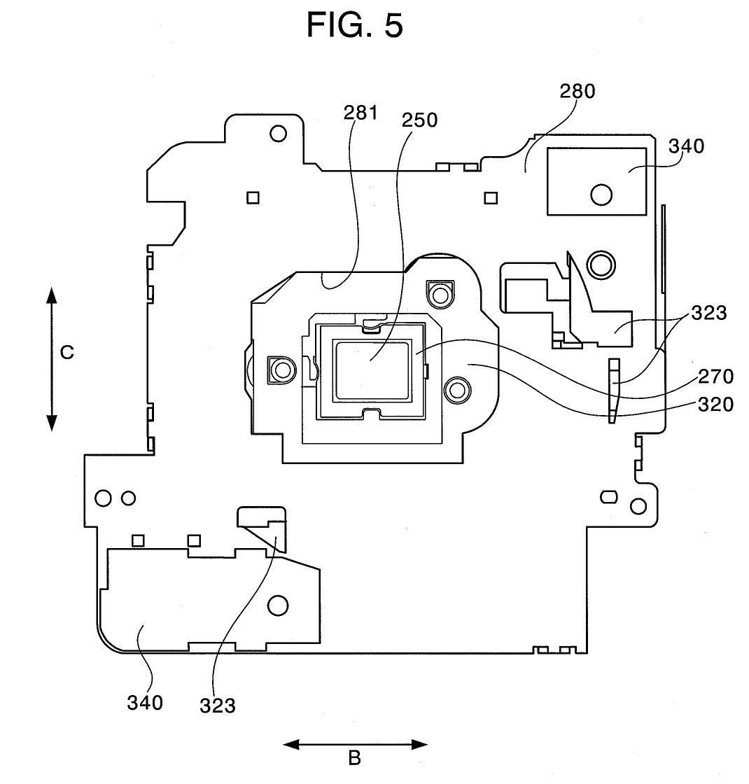

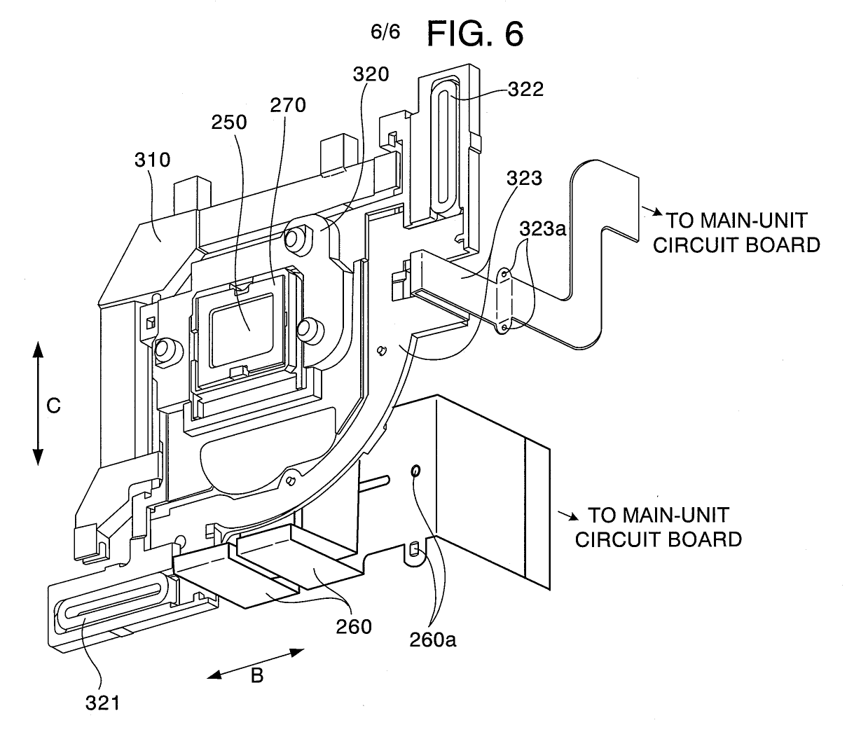

FIG. 4 is a diagram of the base 280 illustrated in FIG. 3 when viewed from the image-forming side (the back side of the camera), FIG. 5 is a diagram of the base 280 illustrated in FIG. 3 when viewed from the subject side (the front side of the camera), and FIG. 6 is a perspective diagram of a first slider 310 and a second slider 320 illustrated in FIG. 5 when viewed from the subject side.

The first slider 310 is supported by the base 280 of the camera main unit 10 (See FIG. 1 and FIG. 2) to be slidable in an arrow-B direction that is an X-direction in an XY plane perpendicular to the optical axis. To be more specific, the first slider 310 is slidably supported by an X1 guide shaft 285 and an X2 guide shaft 286 which extend in an arrow-B direction and are fixed to the base 280.

The second slider 320 is supported by the first slider 310 to be slidable in an arrow-C direction that is a Y-direction in the XY plane perpendicular to the optical axis. To be more specific, the second slider 320 is slidably supported by a Y1 guide shaft 315 and a Y2 guide shaft 316 which extend in the arrow-B direction and are fixed to the first slider 310. Further, to this second slider 320, the CCD plate 270 to which the CCD image sensor 250 is adhered to be fixed is secured. Incidentally, the base 280 has an aperture 281 provided in a central part of the base 280. In FIG. 5, the CCD image sensor 250, the CCD plate 270, and the second slider 320, which are disposed on the image-forming side beyond the base 280, are seen through the aperture 281.

Furthermore, fixed on the second slider 320 are: two coils 321 and 322; and a VCM (Voice Coil Motor) flexible circuit board 323 having ends connected to the coils 321 and 322. The VCM flexible circuit board 323 is shaped like a belt, in which a metal conductor is sandwiched between resin films. This VCM flexible circuit board 323 transmits electric signals to the two coils 321 and 322. Moreover, the two coils 321 and 322 are supplied with electric signals for correcting a blur in a subject image by a camera shake detection sensor and a control circuit, which are not illustrated. Apertures 323a for fixing are formed in a middle portion of a part at a tip of extension from the coils 321 and 322, of the VCM flexible circuit board 323. When bosses 280b formed to protrude on the base 280 are inserted into these apertures 323a, the tip of the extension of the VCM flexible circuit board 323 is fixed to the base 280.

Furthermore, two magnets 331 and 332 are fixed to the base 280 at positions facing the two coils 321 and 322. To be more specific, the magnets 331 and 332 are affixed to a yoke 340, and the yoke 340 is affixed to the base 280.

The combination of the two coils 321 and 322, the VCM flexible circuit board 323, the two magnets 331 and 332, and the yoke 340 is one embodiment of the drive system according to the present invention.

By such a drive system, the second slider 320 is moved relative to the base 280 within the XY plane via the first slider 310. In other words, the CCD plate 270 fixed to the second slider 320 is moved relative to the base 280 within the XY plane to offset the camera shake detected by the camera shake detection sensor (not illustrated), so that blurring of the subject image is corrected by the CCD image sensor 250 adhered to be fixed to the CCD plate 270.

According to the digital camera 1 of the present embodiment, the weight of the CCD plate 270 that is the movable section is supported by the CCD flexible circuit board 260. For this reason, when the camera is supported in the standard posture, a thrust force required of an actuator is small and thus, the actuator may be reduced in size, and power consumption may be reduced. In particular, the CCD flexible circuit board 260 has signal lines more than the VCM flexible circuit board, and is broad and strong in resilience. Therefore, according to the digital camera 1 of the present embodiment, the movable section may be more firmly supported by using an existing CCD flexible circuit board.

Further, according to the digital camera 1 of the present embodiment, the CCD flexible circuit board 260 is bent to be shaped like a letter of U, and thereby it is possible to hold the imaging section (CCD plate 270) at an approximately central position where the center of the imaging element (CCD image sensor 250) agrees with the optical axis, without pushing the imaging section (CCD plate 270) upward.

Incidentally, the exemplary embodiment has been described above by using the example in which the imaging element according to the present invention is a CCD image sensor. However, the imaging element according to the present invention is not limited to this example, and may be, for instance, a CMOS image sensor.

Further, the exemplary embodiment has been described above by using the example in which the image taking apparatus according to the present invention has the zoom lens. However, the image taking apparatus according to the present invention is not limited to this example, and may be, for instance, an apparatus having a lens barrel whose tube length is fixed, or an apparatus having a lens barrel removable from a main unit.

According to the present invention, there is provided the image taking apparatus in which, while an increase in the size of the flexible printed circuit board is avoided, the weight of the movable section for blur correction is firmly supported.

What is claimed is:

1. An image taking apparatus that includes an image-taking optical system, and performs image-taking by capturing subject light incident through the image-taking optical system, the image taking apparatus comprising:
an imaging section in which an imaging element that receives the subject light and generates image signals representing a subject image is disposed;
abase member that supports the imaging section, so that the imaging section is movable within a plane which is perpendicular to an optical axis in which the imaging element receives the subject light;
a drive system that drives the imaging section so that image blurring is corrected; and
a flexible circuit board that transmits the image signals generated by the imaging element to a signal processing circuit board, wherein
the flexible circuit board includes one end connected to the imaging section and the other end connected to the signal processing circuit board, and a middle part between the both ends has a shape of being bent in a direction of preventing the imaging section from falling to support the imaging section elastically.

2. The image taking apparatus according to claim 1, wherein the flexible circuit board has a part that extends in a downward direction perpendicular to the optical axis from the imaging section, bends and extends in a direction of the optical axis at a tip of an extension in the downward direction, and wraps around to form a letter U at a tip of an extension in the direction of the optical axis and returns, and a tip of the part after returning is fixed to the base member.
